(19) United States
(12) Patent Application Publication
(10) Pub. No.: US 2012/0035786 A1
(43) Pub. Date: Feb. 9, 2012

(54) Weight Shifting System for Remote Vehicle

(76) Inventors: Brian Masao Yamauchi, Boston, MA (US); Mark Robert Claffee, Methuen, MA (US)

(21) Appl. No.: 13/009,833

(22) Filed: Jan. 19, 2011

Related U.S. Application Data
(63) Continuation-in-part of application No. 12/853,277, filed on Aug. 9, 2010.

(51) Int. Cl. G05D 1/02; G06F 17/10

(52) U.S. Cl. 701/2; 701/124

(57) ABSTRACT

The present teachings provide a system and a method to shift a center of gravity of an unmanned ground vehicle, the system configured to determine, by a movement sensor, a present turn angle of the vehicle, determine, by a processor, a desired turn angle of the vehicle according to a turn command received from a remote control device, determine, by the processor, a difference between the present turn angle and the desired turn angle, and control, by the processor, a weight shifting system of the vehicle to relocate a weight movably attached to the weight shifting system based on the difference between the present turn angle and the desired turn angle.

### CROSS REFERENCE TO RELATED APPLICATIONS

The present application is a continuation-in-part from U.S. patent application Ser. No. 12/853,277, filed Aug. 9, 2010, the entire content of which is incorporated herein by reference.

### BACKGROUND

When a ground vehicle exceeds the limits of tire or track grip when turning a corner, the vehicle may understeer, oversteer, or roll over. Understeering occurs when the front of the vehicle loses grip first, and the vehicle turns less than desired. Oversteering occurs when the rear of the vehicle loses grip first, and the vehicle turns more than desired. Rollover occurs when turning forces cause the vehicle to lift off its inside wheels or tracks and flip over onto its side or top.

Conventional dynamic stability control systems address oversteering and understeering by, for example, comparing the vehicle's actual yaw rate with the commanded yaw rate and taking actions such as reducing throttle or applying brakes to regain control.

### SUMMARY

The present teachings provide a system to shift a center of gravity of an unmanned ground vehicle, the system comprising a first guide attached to the vehicle substantially parallel to the forward direction of motion of the vehicle, a second guide attached to the vehicle substantially parallel to the forward direction of motion of the vehicle, a support guide movably attached to the first guide and to the second guide, extending between the first guide and the second guide, and configured to move along a lengthwise direction of the first guide and the second guide, a weight movably attached to the support guide and configured to move along a lengthwise direction of the support guide, wherein the lengthwise direction of the support guide is substantially perpendicular to the forward direction of motion of the vehicle, a first motor configured to move the support guide along the first guide and the second guide, a second motor configured to move the weight along the support guide, and a control interface coupled to the first motor and the second motor and configured to control the first motor and the second motor.

The present teachings also provide an unmanned ground vehicle comprising a central processing unit (CPU), a movement sensor coupled to the CPU and configured to sense a present turn angle of the vehicle and communicate the present turn angle to the CPU, a location sensor coupled to the CPU and configured to determine a present location of the vehicle and communicate the present location to the CPU, a speed sensor coupled to the CPU and configured to determine a present speed of the vehicle and communicate the present speed to the CPU, a wireless communication unit coupled to the CPU and configured to receive control information from a remote operation control unit and communicate the control information to the CPU, and a weight shifting system coupled to the CPU and configured to shift a center of gravity of the vehicle based on at least one of the present turn angle of the vehicle, the present location of the vehicle, the present speed of the vehicle, and the received control information.

The present teachings further provide a method to shift a center of gravity of an unmanned ground vehicle, the method comprising determining, by a movement sensor, a present turn angle of the vehicle, determining, by a processor, a desired turn angle of the vehicle according to a turn command, determining, by the processor, a difference between the present turn angle and the desired turn angle, and controlling, by the processor, a weight shifting system of the vehicle to relocate a weight movably attached to the weight shifting system based on the difference between the present turn angle and the desired turn angle.

The present teachings further provide a method to shift a center of gravity of an unmanned ground vehicle, the method comprising determining, by a location sensor, a present location of the vehicle, determining, by a speed sensor, a present speed of the vehicle, determining, by a movement sensor, a present turn angle of the vehicle, determining, by a processor, a planned turn angle of the vehicle at a planned location of the vehicle according to a planned path, and controlling, by the processor, a weight shifting system of the vehicle to relocate a weight movably attached to the weight shifting system based on at least one of the present location of the vehicle, the present speed of the vehicle, the present turn angle of the vehicle, and the planned turn angle of the vehicle at the planned location of the vehicle.

Additional objects and advantages of the present teachings will be set forth in part in the description which follows, and in part will be obvious from the description, or may be learned by practice of the present teachings. The objects and advantages of the present teachings will be realized and attained by means of the elements and combinations particularly pointed out in the appended claims.

### BRIEF DESCRIPTION OF THE DRAWINGS

FIG. 1 is a top perspective view of an exemplary embodiment of a weight shifting system in accordance with the present teachings.

FIG. 2 is a flowchart illustrating a process of operating an exemplary embodiment of a weight shifting system in accordance with the present teachings.

FIG. 3 is another flowchart illustrating a process of operating an exemplary embodiment of a weight shifting system in accordance with the present teachings.

FIG. 4 is a side perspective view of an exemplary embodiment of a weight shifting system in accordance with the present teachings, mounted on a remote vehicle.

FIG. 5A illustrates a remote vehicle having a weight shifting system in accordance with the present teachings, the remote vehicle turning a corner without employing active weight shifting.

FIG. 5B illustrates a remote vehicle having a weight shifting system in accordance with the present teachings, the remote vehicle turning a corner while employing active weight shifting.

### DETAILED DESCRIPTION

The foregoing general description, the following detailed description, and the accompanying drawings, are exemplary and explanatory only and are not restrictive of the present invention, as claimed. The following detailed description and accompanying drawings teach the best mode of the invention. For the purpose of teaching inventive principles, some aspects of the best mode may be simplified or omitted where they would be known to those of ordinary skill in the art.

The appended claims specify the scope of the invention. Some aspects of the best mode may not fall within the scope of the invention as specified by the claims. Thus, those skilled in the art will appreciate variations from the best mode that fall within the scope of the invention. Those skilled in the art will also appreciate that the features described below can be combined in various ways to form multiple variations of the invention. As a result, the invention is not limited to the specific examples described below, but only by the claims and their equivalents.

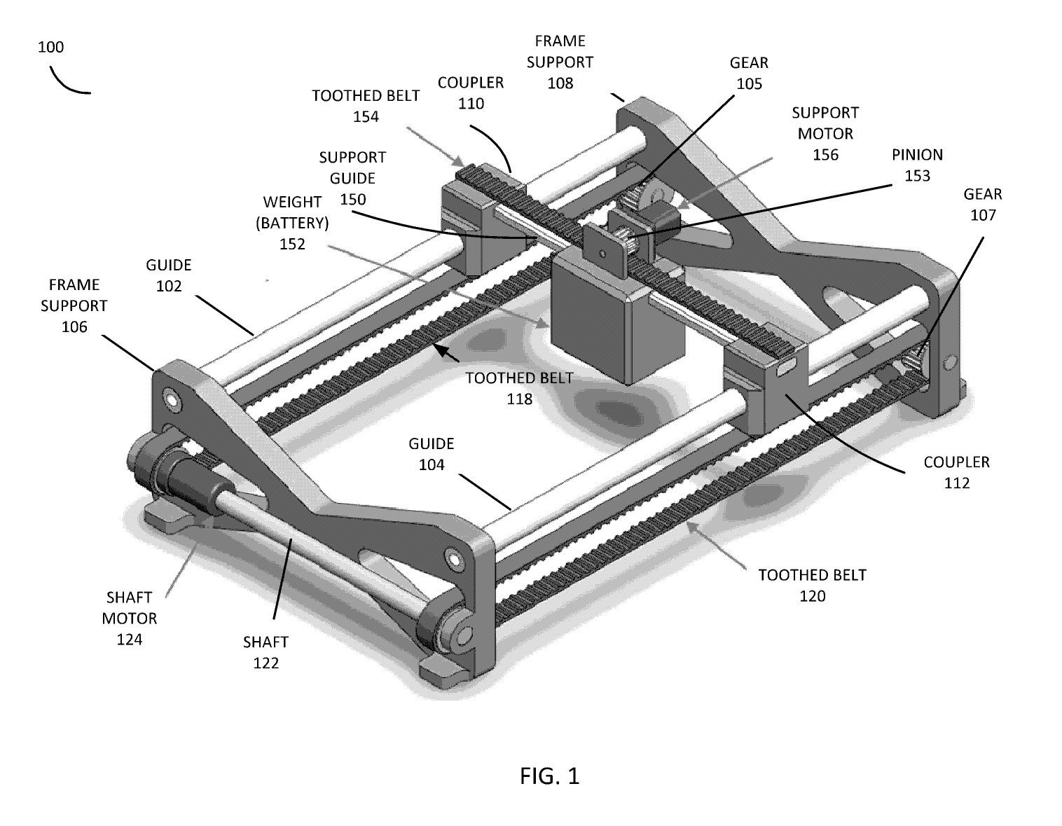

FIG. 1 illustrates an exemplary embodiment of a weight shifting system 100, including certain aspects of the present teachings. Weight shifting system 100 includes a rectangular frame comprising guides 102 and 104 extending longitudinally between frame supports 106 and 108. Weight shifting system 100 further includes a support guide 150 which extends laterally from guide 102 to guide 104, perpendicular to guides 102 and 104. Support guide 150 includes sliding couplers 110 and 112 that slide along guides 102 and 104, respectively.

Weight shifting system 100 further includes toothed belts 118 and 120 running under and parallel to guides 102 and 104, respectively, and attached to a circular drive gears 105 and 107, respectively, at frame support 108. Toothed belts 118 and 120 can be, for example, fixedly attached to sliding couplers 110 and 112, respectively, so that circulating toothed belts 118 and 120 through the circular gears 105 and 107 can cause sliding couplers 110 and 112 to slide along guides 102 and 104, respectively.

Weight shifting system 100 further includes a shaft element 122 attached to toothed belts 118 and 120 to circulate the toothed belts 118 and 120 (e.g., via gears on each side of the shaft that engage the teeth of the belts), and shaft motor 124 connected to shaft elements 122 for rotating shaft element 122. When rotated, shaft element 122 rotates to circulate toothed belts 118 and 120 to move sliding couplers 110 and 112 along guide members 102 and 104, respectively, and thus move support guide 150 along the frame.

Support guide 150 further includes slidable weight 152, a toothed belt 154, a pinion 153 attached to weight 152 and configured to move along toothed belt 154, and a support motor 156 to drive (i.e., rotate) pinion 153. Weight 152 may be any physical element providing enough weight to cause a shift in the center of gravity of the vehicle when relocated from one location of the weight shifting system to another. The physical element preferably comprises an element with a second purpose in the vehicle, such as a battery to power one or more components of the vehicle, a control unit for controlling one or more components of the vehicle, or a gas or other fluid tank. The physical element may also be a simple weight without a secondary purpose.

Weight 152 is preferably attached to support guide 150 such that it can slide along support guide 150 between sliding couplers 110 and 112. Toothed belt 154 can be disposed along support guide 150, and can be attached to sliding couplers 110 and 112. Support motor 156 drives (i.e., rotates) pinion 153 to move the weight along the toothed belt 154 between coupler 110 to coupler 112.

One skilled in the art will understand that an active weight shifting system in accordance with the present teachings need not employ a gear-based mechanism to move the weight to the sides and/or to the front and back of the remote vehicle, but rather can utilize other known drive mechanisms such as, for example, hydraulic drive mechanisms. The same type of mechanism need not be used for both side-to-side and front-to-back movement of the weight.

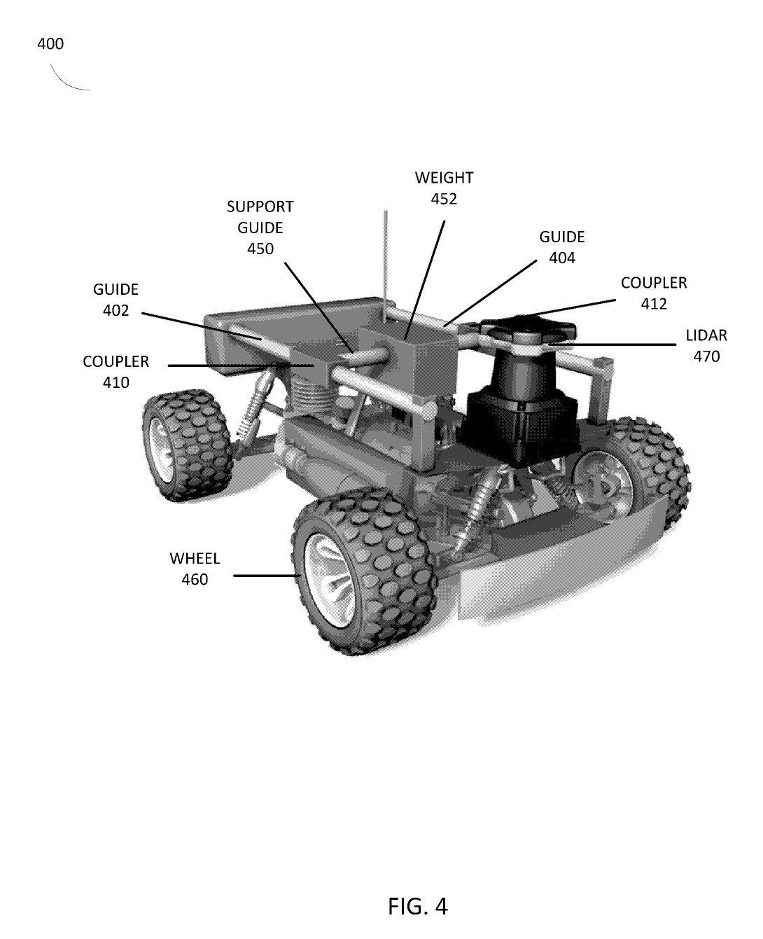

In operation, weight shifting system 100 can be implemented in a vehicle as an added feature to an existing vehicle or can be built into the vehicle. The weight shifting system preferable operates in a horizontal plane of the vehicle as shown in FIG. 4. When the vehicle needs to shift its center of gravity, for example to counteract oversteer or understeer or prevent rollover, the vehicle can control weight shifting system 100 to move weight element 152 to a desired location longitudinally and laterally along shifting system 100's rectangular frame.

In accordance with certain embodiments of the present teachings, one or more processors (e.g., one or more of the vehicle's processors) can communicate with weight shifting system 100 to control shaft motor 124 to adjust the location of support guide 150 (and thus the location of weight 152) longitudinally along guides 102 and 104, and support motor 156 to adjust the location of weight 152 laterally along support guide 150. Relocation of weight 152 causes the center of gravity of the vehicle to shift to counteract oversteer, understeer, or a rollover tendency.

A weight shifting system consistent with the present teachings can be used as a driver assist behavior to support augmented teleoperation of remote vehicles, or it can be combined with autonomous behaviors to provide fully autonomous control of high speed vehicles that can perform aggressive maneuvers. For teleoperation, the driver would control the vehicle, and the weight shifting system may assist by shifting its weight element to maintain stability when driver commands would cause the vehicle to oversteer, understeer, or roll over. For autonomous operation, other behaviors (e.g. path planning, obstacle avoidance, pursuit/evasion) would determine the vehicle's path, and the weight shifting system may improve the vehicle's stability when following the selected path, by, for example, shifting the center of gravity in anticipation of an upcoming turn.

The weight shifting system may be integrated with the vehicle's Dynamic Stability Control (DSC) system, when such a system is available. When the vehicle understeers (turns at a lower rate than commanded) or oversteers (turns at a higher rate than commanded) a DSC system may react by reducing throttle or applying brakes selectively to individual wheels to control and minimize the slip angle (i.e., the angle between a wheel's orientation and its direction of travel). In an exemplary embodiment of the present teachings, the DSC system can control a weight shifting system of the present teachings to shift the center of gravity of the vehicle in response to a detected slip angle, thus giving the DSC an additional option for stability control. The shift of the center of gravity, alone or in combination with other corrective actions, may reduce the slip angle and improve the vehicle's maneuverability, particularly at higher speeds.

The embodiment of FIG. 1 is intended to be exemplary, and it would be apparent to one skilled in the art that certain aspects of the present teachings may be implemented in a plurality of ways. For example, sliding couplers 110 and 112 and support guide 150 may move along guides 102 and 104 in a variety of ways, including a rack and pinion system in which a motor resides at one or both of the sliding couplers and drives a circular pinion to engage the teeth of a linear gear parallel to, or along guides 102 and 104. Also, weight element 152 may move along support guide 150 in a variety of ways, including a motor attached to one of the couplers to drive a circular gear coupled to a toothed belt attached to weight 152. Circulating the toothed belt would move weight 152 along support guide 150.

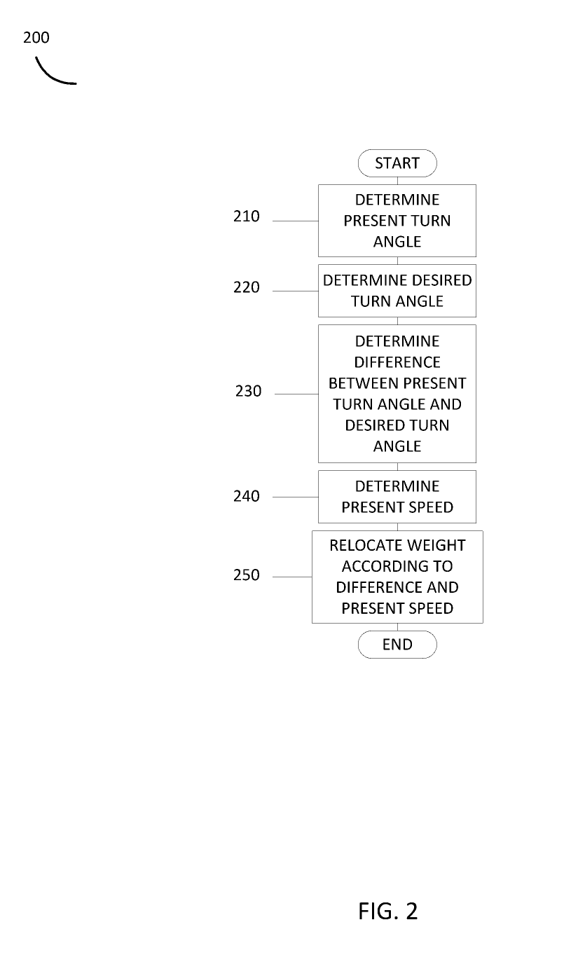

FIG. 2 illustrates an exemplary process 200 for operating a weight shifting system such as the system 100 of FIG. 1 in an unmanned ground vehicle, including certain aspects of the present teachings. At step 210, the vehicle determines a present turn angle of the vehicle, which indicates the present direction of movement of the vehicle. The present turn angle may be determined by a processor based on environmental information received from an Inertial Measurement Unit (IMU) or other component capable of providing directional/movement information. At step 220, the vehicle determines a desired turn angle of the vehicle, which indicates the desired direction of movement of the vehicle. The desired turn angle can be determined based on, for example, a command received from a remote control device, but the present teachings are not so limited. For example, the desired turn angle can alternatively be determined based on a planned path of the vehicle or on mapping information of the environment proximal to the vehicle (e.g., turn angle necessary to avoid an obstacle), without departing from the spirit of the present teachings.

At step 230, the vehicle determines a difference between the present turn angle and the desired turn angle, and at step 240 the vehicle determines the present speed of the vehicle. The speed of the vehicle may be determined based on a global positioning system, a speedometer, or any other manner of measuring speed known in the art. At step 250, the processor controls the weight shifting system to move a weight movably attached to the weight shifting system, the movement of the weight being based on, for example, the difference between the present turn angle and the desired turn angle and the present speed of the vehicle.

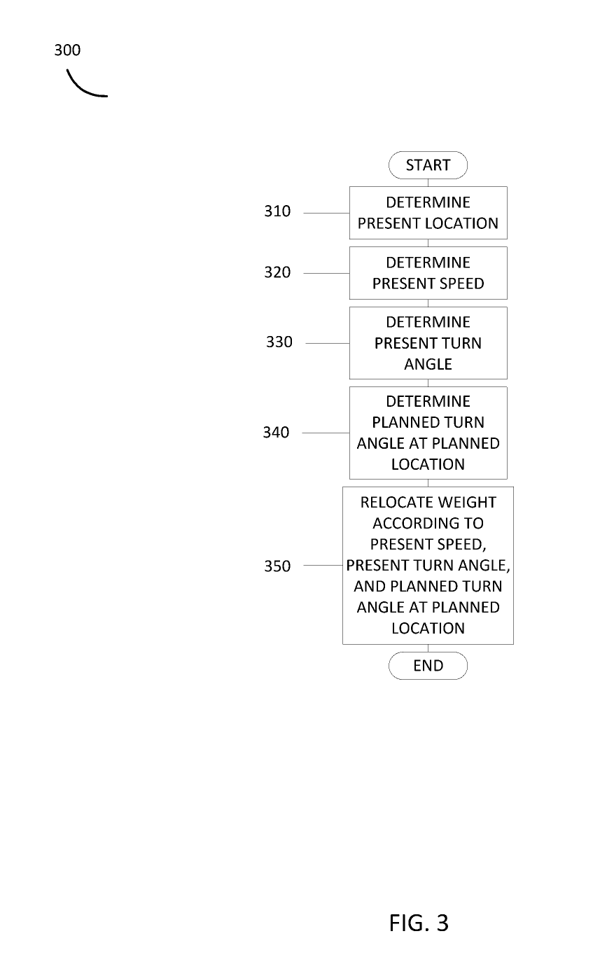

FIG. 3 illustrates a process 300 for operating weight shifting system such as the system 100 of FIG. 1 in an unmanned ground vehicle, including certain aspects of the present teachings. At step 310, the vehicle determines a present location of the vehicle. The present location may be determined in a variety of ways, including via a global positioning system and/or via a planar laser-based Simultaneous Localization and Mapping (SLAM) system, or any other known system for determining a present location without departing from the spirit of the present teachings.

At step 320, the vehicle determines the present speed of the vehicle. The speed of the vehicle may be determined based on a global positioning system, a speedometer, or any other manner of measuring speed known in the art. At step 330, the vehicle determines a present turn angle of the vehicle. The present turn angle may be determined by a processor based on environmental information received from an Inertial Measurement Unit (IMU) or other component capable of providing directional/movement information.

At step 340, the vehicle determines a planned turn angle of the vehicle at a planned location of the vehicle. The planned turn angle at the planned location may be based on path planning information received from a source external to the vehicle or on a path determined by the vehicle according to environmental conditions (e.g., obstacle avoidance). At step 350, the vehicle controls a weight shifting system of the vehicle to relocate a weight movably attached to the weight shifting system based on at least one of the present location of the vehicle, the present speed of the vehicle, the present turn angle of the vehicle, and the planned turn angle of the vehicle at the planned location of the vehicle.

The exemplary embodiment illustrated in FIG. 3 relates to using a planned path to anticipate an upcoming turn and relocate the weight shifting system's weight to a desired location before reaching the upcoming turn, as opposed to relocating the weight shifting system's weight in reaction to an oversteer/understeer situation (i.e., relocating the weight after detecting a slip angle). Thus, in addition to reducing a slip angle, the present embodiment may prevent a slip angle altogether.

FIG. 4 illustrates a vehicle 400, which includes certain aspects of the present teachings. In particular, vehicle 400 illustrates an exemplary unmanned ground vehicle including an exemplary embodiment of a weight shifting system according to the present teachings. Vehicle 400 includes guides 402 and 404 and support guide 450 which extends from guide 402 to guide 404, perpendicular to guides 402 and 404.

Support guide 450 includes sliding couplers 410 and 412 for sliding support guide 450 along guides 402 and 404. Support guide 450 further includes sliding weight element 452 movably attached to support guide 450 and is configured to slide along support guide 450 between sliding couplers 410 and 412. Weight element 452 can, for example, comprise a battery for providing energy to one or more components of the vehicle.

Vehicle 400 can also include a Central Processing Unit (CPU) (not shown) for processing information such as control and environmental data, and environment sensors for providing environmental data, such as a Global Positioning System (GPS) for providing location data and speed data, an Inertia Measurement Unit (IMU) for providing turn/yaw rate data, and a Light Detection and Ranging (LIDAR) unit 470 for providing proximity data. Vehicle 400 may further include a planar laser-based Simultaneous Localization and Mapping (SLAM) system for environment mapping and path planning, and a stereo vision camera to capture environment information and provide a 3-Dimensional (3D) volumetric picture element (VOXEL)-based representation of the environment.

The environmental data can be used for path planning and vehicle control, including weight shifting control in accordance with various embodiments of the present teachings. The environmental data may also be used in combination with an Operation Control Unit (OCU) (not shown) remotely controlling the vehicle. The OCU may allow a user to manually control the vehicle 400's speed and direction and provide visual feedback to the user by projecting in input from the vehicle's stereo vision camera.

An environment can be defined as a physical area that has a defined coordinate system for implementing a localization strategy and a path planning strategy. For example, an outdoor environment may be mapped according to a GPS-based coordinate system with a waypoint planning path strategy and GPS-based localization. An indoor environment (in which GPS may not be available) may be mapped according to a coordinate system defined using a planar laser-based SLAM strategy. Other embodiments may use, for example, a 3-Dimensional (3D) volumetric picture element (VOXEL)-based representation of an area based on stereo-vision information of the area, a 3D-based SLAM, or SLAM for a predetermined remote vehicle sensor.

Other aspects of the present teachings described with respect to weight shifting system 100 of FIG. 1 are not shown for simplicity or are not visible in FIG. 4, and their description is therefore omitted. Furthermore, particular elements of vehicle 400 illustrated in FIG. 4 (e.g., wheel 460) will not be described for the purposes of simplicity.

In operation, vehicle 400 captures and analyses environment data from, for example, a GPS system (e.g., vehicle location and speed), a IMU (e.g., actual turn rate/yaw rate), and/or a LIDAR unit 470 (e.g., mapping of the proximate environment and/or an obstacle detection/obstacle avoidance behavior). The CPU processes the environment data, as well as any control data (e.g., desired speed and direction based on either manual control through an OCU or a planned path) to determine if a shift of the vehicle's center of gravity is required. If a shift is required, the vehicle CPU can control the weight shifting system to move a weight 452 to a desired location along the vehicle. Relocation of weight 452 causes the center of gravity of the vehicle to shift to reduce/minimize oversteering, understeering, and/or a vehicle's rollover tendency.

For example, and not as a limitation, when vehicle 400 operates under a planned path, the GPS can provide the current location and speed of the vehicle 400 in real-time to a CPU. A LIDAR sensor can provide a real-time map of the environment proximal to the vehicle 400 (e.g., nearby objects or obstacles) to the CPU. The CPU can then control the vehicle's speed and direction according to the planned path and the real-time map. When the CPU determines that a desired turn may cause the vehicle to understeer, oversteer, or rollover, the CPU determines where the weight of the weight shifting system should be located to achieve a desired shift of the center of gravity and controls the weight shifting system to relocate the weight to the determined location. This weight shift may be performed independently or in combination with other actions, such as controlling the speed of one or more of the vehicle's wheels. After the vehicle completes the turn, the CPU may return the weight to its previous location or to a predetermined location.

As a further example, and not as a limitation, when a vehicle such as vehicle 400 of FIG. 4 operates under user control (i.e., the user controls the direction and/or speed of the vehicle), the GPS system may provide the current location of the vehicle 400 and its current speed to the CPU. The LIDAR may provide a map of the environment and be utilized to avoid collisions, with the CPU controlling the vehicle according to the user's commands. When the user requests the vehicle to turn, the CPU determines whether a shift of the center of gravity is needed and/or would aid in stabilizing the vehicle through the requested turn. If the CPU determines that a shift is necessary or desirable, the CPU can then determine where the weight of the weight shifting system should be relocated to achieve a desired shift of the center of gravity, and control the weight shifting system to relocate the weight to the determined location. This weight shift may be performed independently or in combination with other actions, such as controlling the speed of one or more of the vehicle's wheels. After the vehicle completes the turn, the CPU may return the weight to its previous location or to a predetermined location.

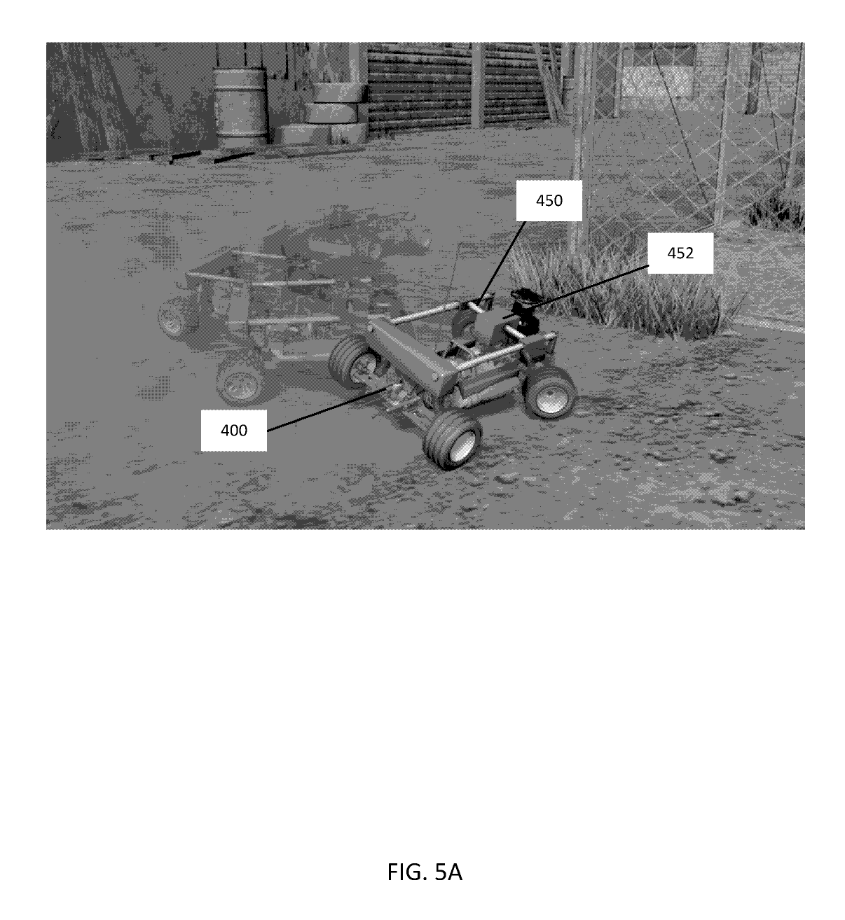

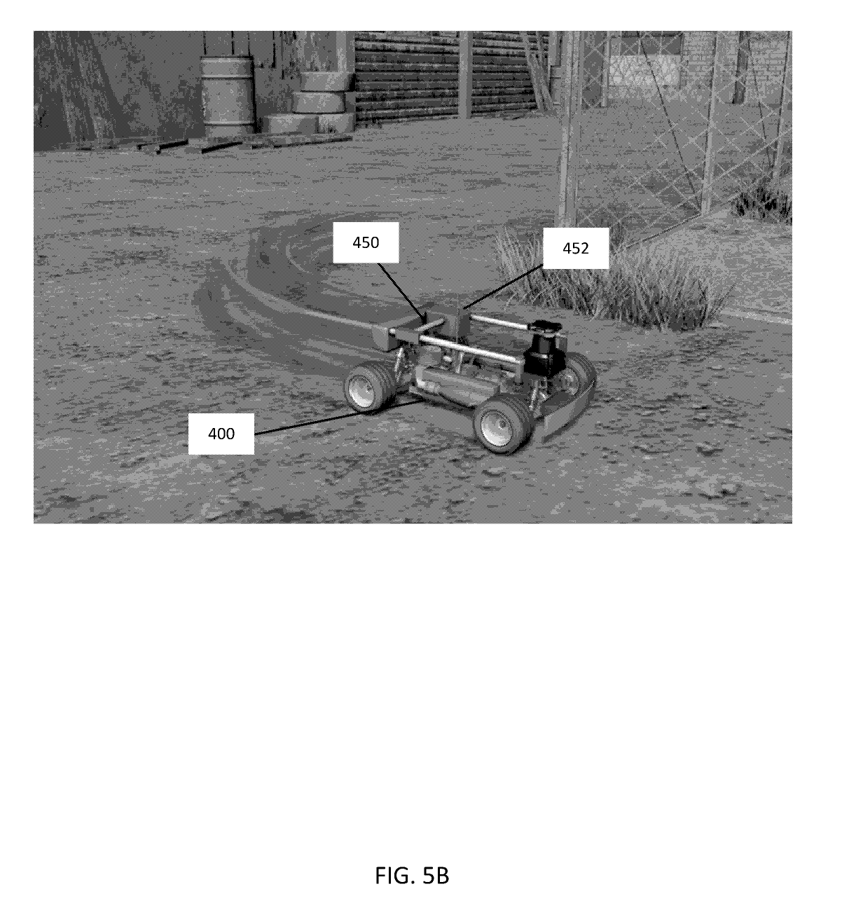

FIGS. 5A and 5B illustrate exemplary operations of vehicle 400 according to certain aspects of the present teachings. FIG. 5A depicts vehicle 400 taking a sharp turn at high speed with weight 452 being located near the front of the vehicle 400 and near the center of support guide 450. With this arrangement of the weight 452, vehicle 400 oversteers and spins out of control. In contrast, FIG. 5B depicts vehicle 400 taking the same sharp turn at high speed, but with weight 452 located near the back and towards the left side of vehicle 400. This rear and left location of weight 452 prevents oversteering during the sharp turn as shown.

Some or all of the actions performed by the exemplary embodiments described herein can be performed under the control of a computer system executing computer-readable codes either in a computer-readable recording medium or in communication signals transmitted through a transmission medium. The computer-readable recording medium is any data storage device that can store data for a non-fleeting period of time such that the data can thereafter be read by a computer system. Examples of the computer-readable recording medium include, but are not limited to, read-only memory (ROM), random-access memory (RAM), CD-ROMs, magnetic tapes, floppy disks, and optical data storage devices. The computer-readable recording medium can also be distributed over network-coupled computer systems so that the computer-readable code is stored and executed in a distributed fashion. The communication signals transmitted through a transmission medium may include, for example, signals which modulate carrier waves transmitted through wired or wireless transmission paths.

The above description and associated figures teach the best mode of the invention. Other embodiments will be apparent to those skilled in the art from consideration of the specification and practice of the teachings disclosed herein. It is intended that the specification and examples be considered as exemplary only, with a true scope and spirit invention being indicated by the following claims.

What is claimed is:

1. A system to shift a center of gravity of an unmanned ground vehicle, the system comprising:
a first guide attached to the vehicle substantially parallel to the forward direction of motion of the vehicle;
a second guide attached to the vehicle substantially parallel to the forward direction of motion of the vehicle;
a support guide movably attached to the first guide and to the second guide, extending between the first guide and the second guide, and configured to move along a lengthwise direction of the first guide and the second guide;
a weight movably attached to the support guide and configured to move along a lengthwise direction of the support guide, wherein the lengthwise direction of the support guide is substantially perpendicular to the forward direction of motion of the vehicle;
a first motor configured to move the support guide along the first guide and the second guide;
a second motor configured to move the weight along the support guide; and
a control interface coupled to the first motor and the second motor and configured to control the first motor and the second motor.

2. The system of claim 1, further comprising:
a first sliding coupler fixedly attached to a first end of the support guide, movably attached to the first guide, and configured to slide along the first guide;
a second sliding coupler fixedly attached to a second end of the support guide, movably attached to the second guide, and configured to slide along the second guide;
a first belt disposed along the lengthwise direction of the first guide, coupled to a shaft coupled to the first motor, and fixedly attached to the first sliding coupler;
a second belt disposed along the lengthwise direction of the second guide, coupled to the shaft coupled to the first motor, and fixedly attached to the second sliding coupler; and
a third belt disposed along the support guide, coupled to a gear coupled to the second motor, and attached to the first sliding coupler and the second sliding coupler,
wherein the first motor is configured to circulate the first and second belts to slide the first and second sliding couplers, respectively, along the first and second guides, respectively, when the first motor is activated, and
the second motor is configured to engage the third belt to move the weight along the support guide when the second motor is activated.

3. The system of claim 2, wherein the weight element comprises a battery.

4. An unmanned ground vehicle, comprising
a central processing unit (CPU);
a movement sensor coupled to the CPU and configured to sense a present turn angle of the vehicle and communicate the present turn angle to the CPU;
a location sensor coupled to the CPU and configured to determine a present location of the vehicle and communicate the present location to the CPU;
a speed sensor coupled to the CPU and configured to determine a present speed of the vehicle and communicate the present speed to the CPU;
a wireless communication unit coupled to the CPU and configured to receive control information from a remote operation control unit and communicate the control information to the CPU; and
a weight shifting system coupled to the CPU and configured to shift a center of gravity of the vehicle based on at least one of the present turn angle of the vehicle, the present location of the vehicle, the present speed of the vehicle, and the received control information.

5. The unmanned ground vehicle of claim 4, wherein the weight shifting system comprises:
a first guide attached to the vehicle substantially parallel to the forward direction of motion of the vehicle;
a second guide attached to the vehicle substantially parallel to the forward direction of motion of the vehicle;
a support guide movably attached to the first guide and to the second guide, extending between the first guide and the second guide, and configured to move along a lengthwise direction of the first guide and the second guide;
a weight movably attached to the support guide and configured to move along a lengthwise direction of the support guide, wherein the lengthwise direction of the support guide is substantially perpendicular to the forward direction of motion of the vehicle;
a first motor configured to move the support guide along the first guide and the second guide;
a second motor configured to move the weight along the support guide; and
a control interface coupled to the first motor and the second motor and configured to control the first motor and the second motor,
wherein the weight shifting system communicates with the CPU through the control interface.

6. The unmanned ground vehicle of claim 5, wherein the movement sensor comprises an inertia measurement unit.

7. The unmanned ground vehicle of claim 5, wherein the location sensor and the speed sensor comprise a global positioning system unit.

8. The unmanned ground vehicle of claim 5, further comprising a ranging and proximity sensor configured to detect mapping information of an environment proximal to the unmanned ground vehicle and provide the mapping information to the CPU.

9. The unmanned ground vehicle of claim 8, wherein the ranging and proximity sensor comprises a light detection and ranging unit (LIDAR or LADAR).

10. The unmanned ground vehicle of claim 8, wherein the received control information comprises a planned path and the CPU is configured to control the vehicle to navigate through the planned path based on the mapping information.

11. The unmanned ground vehicle of claim 10, wherein, when the planned path comprises a predetermined turn at a desired turn angle and a desired speed, and the CPU controls the weight shifting system to shift a center of gravity of the vehicle based on at least one of the desired turn angle, the desired speed, the present turn angle of the vehicle, the present speed of the vehicle, and the present location of the vehicle.

12. The unmanned ground vehicle of claim 5, wherein, when the received control information comprises a desired turn angle and a desired speed, and the CPU controls the weight shifting system to shift a center of gravity of the vehicle based on at least one of the desired turn angle, the desired speed, the present turn angle of the vehicle, the present speed of the vehicle, and the present location of the vehicle.

13. A method to shift a center of gravity of an unmanned ground vehicle, the method comprising:
determining, by a movement sensor, a present turn angle of the vehicle;
determining, by a processor, a desired turn angle of the vehicle according to a turn command;
determining, by the processor, a difference between the present turn angle and the desired turn angle; and
controlling, by the processor, a weight shifting system of the vehicle to relocate a weight movably attached to the weight shifting system based on the difference between the present turn angle and the desired turn angle.

14. The method of claim 13, further comprising:
determining, by a speed sensor, a present speed of the vehicle,
wherein the controlling of the weight shifting system is further based on the present speed of the vehicle.

15. The method of claim 14, wherein the movement sensor comprises an inertial measurement unit and the speed sensor comprises a global positioning system.

16. A method to shift a center of gravity of an unmanned ground vehicle, the method comprising:
determining, by a location sensor, a present location of the vehicle;
determining, by a speed sensor, a present speed of the vehicle;
determining, by a movement sensor, a present turn angle of the vehicle;
determining, by a processor, a planned turn angle of the vehicle at a planned location of the vehicle according to a planned path; and
controlling, by the processor, a weight shifting system of the vehicle to relocate a weight movably attached to the weight shifting system based on at least one of the present location of the vehicle, the present speed of the vehicle, the present turn angle of the vehicle, and the planned turn angle of the vehicle at the planned location of the vehicle.

17. The method of claim 16, wherein the movement sensor comprises an inertial measurement unit, and the speed sensor and the location censor comprise a global positioning system.

18. The method of claim 16, wherein the movement sensor comprises an inertial measurement unit and the location censor comprises a ranging and proximity sensor configured to detect mapping information of an environment proximal to the unmanned ground vehicle and provide the mapping information to the processor.
